(19) United States
(12) Patent Application Publication
(10) Pub. No.: US 2006/0150602 A1
(43) Pub. Date: Jul. 13, 2006

(54) Method and apparatus for remotely assisted harvester

(76) Inventor: Eric Michael Stimmann, San Jose, CA (US)

Correspondence Address: LEVINE BAGADE LLP, 2483 EAST BAYSHORE ROAD, SUITE 100, PALO ALTO, CA, 94303, US

(21) Appl. No.: 11/031,113

(22) Filed: Jan. 7, 2005

(51) Int. Cl. A01D 75/28

(52) U.S. Cl. 56/10.5

(57) ABSTRACT

The present invention provides methods for remotely assisted harvesting. Additionally, the present invention provides a harvester that is assisted by a remote operator. The apparatus is designed to be moved through a field harvesting agricultural products. Cameras of the apparatus image the objects to be harvested. The image is sent through a set of antennas and cables to a remote operator who can command the camera pointing, view the crop, and selected fruit to be harvested. The objects are harvested with flexible arms and a collection device. The cameras, harvester arms, collectors, and communication equipment are controlled by a computer on the harvesting apparatus. The object selection information is transmitted to the harvester from the remote operator. The harvester computer uses the selection information to guide the collectors to a location near the object to be harvested. The harvester computer then uses sensors on the collector to precisely locate the object. The collector then collects the object.

### BACKGROUND OF THE INVENTION

1. Field of the Invention

The present invention provides a remotely assisted harvester. More, particularly, the present invention pertains specifically to such apparatus for the remotely assisted guidance of an automated picking device.

2. Description of the Related Art

Manual labor is effective for harvesting, but the cost and complexity of obtaining manual labor for harvesting has increased over time. Manual laborers for agriculture are exposed to many hazards including falling, repetitive stress injuries, injury from machinery, and exposure to chemicals and other agricultural hazards. Additionally, mechanization research and development has diminished in recent decades and, therefore, the need for manual labor in agriculture has not diminished significantly.

There are many manual tools to assist in harvesting. These tools are able to successfully grasp and remove objects from their host plant as long as they are position at the fruit or in close proximity to the objects.

Mechanization is commonplace for crops such as grains, almonds, corn, canning tomatoes, soybeans, rapeseed, potatoes, walnuts, wine grapes, cotton, and carrots. On the other hand, there is limited or no mechanization for crops such as apples, pears, strawberries, artichokes, table tomatoes, cucumbers, cherries, olives, berries, plums, table grapes, peaches, lettuce, table citrus, pumpkins, melons, nursery plants, and flowers.

A number of systems have been developed to use machine vision to implement harvesting. For example, U.S. Pat. No. 4,532,757 discloses a device that locates citrus by color and contains a harvesting arm to pick the fruit. Another example, U.S. Pat. No. 5,426,927 discloses a system that detects, ranges, and picks fruit.

Many automated systems were of limited success in that the harvesting yield was too low while the system cost, complexity, and difficulty of operation was too high. Additionally, some mechanized harvesting systems can damage the plants from which the products are being harvested. Among the most significant problems with machine vision based systems is that fruit are often partially obscured by leaves or other fruit. By way of example, another significant problem is that for some plants, the fruit mature at different times and thus for the these multi-pass harvest plants, the system must be able to accurately determine fruit ripeness. This task is relatively easy for manual labor, but very difficult for a computer or other electronic inspection device. Furthermore, there have been many attempts to develop fully automated harvesters that contained effective fruit collection devices but did not contain an efficient or effective method of determining the location of objects to be collected.

Accordingly, what is required is a system that can combine the ability of a manual harvester to select and classify the object being harvested, along with the efficiency and safety advantages of an automated picker.

### BRIEF SUMMARY OF THE INVENTION

It is therefore an objective of this invention to provide a remotely assisted harvesting tool that can efficiently harvest produce to overcome the deficiencies of the prior art devices.

An additional objective of the present invention is to provide the remotely assisted guidance of an automated picking device that overcomes deficiencies in mechanized produce harvest.

Another object of the present invention is to provide the remotely assisted guidance of an automated picking device that overcomes deficiencies in machine vision for identifying of the locating of the objects being harvested.

Another objective of the present invention is to provide the remotely assisted guidance of an automated picking device that overcomes deficiencies in machine vision for the identification of sufficiently ripe objects to be harvested.

Another objective of the present invention is to provide the remotely assisted guidance of an automated picking device that overcomes deficiencies in machine vision for the identification of sufficiently sized fruit to be harvested.

Another objective of the present invention is to provide the remotely assisted guidance of an automated picking device that overcomes deficiencies in mechanized harvest by allowing the use of wireless and non-wireless communication to connect the harvester to a remote operator.

Another objective of the present invention is to provide the remotely assisted guidance of an automated picking device that is more universally functional in today's market than the prior art devices.

This invention has utility with remote assistance of a variety of harvesters. There is, however, no intention to limit the invention to harvesters. This invention may be applied to a broad variety of devices that can be remotely assisted.

### BRIEF DESCRIPTION OF THE DRAWINGS

FIG. 1 is a side view of a remotely assisted guidance of an automated picking device according to the present invention.

FIG. 2 is a view showing an example of fruit detection by remotely assisted guidance of an automated picking device according to the present invention.

FIG. 3 is a side view of an embodiment of a remotely assisted guidance of an automated picking device according to the present invention.

FIG. 4 is a view of the computer screen of the remote operator according to the present invention.

FIG. 5 is a cross sectional view of a picking device with a built in camera for locating objects to be picked according to the present invention.

FIG. 6 illustrates an embodiment of the wireless and cable connections that can link the automated picking device with the remote operator.

FIG. 7 illustrates and embodiment of the remote operator.

### DETAILED DESCRIPTION

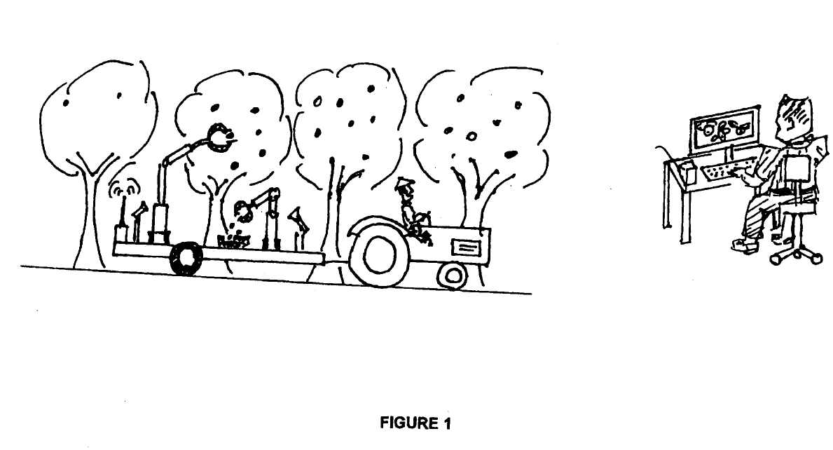

FIG. 1 illustrates a method and apparatus for remotely assisted picking and shows harvesting in one location with the harvester platform being controlled locally by a local field operator, while the harvester device is being controlled remotely.

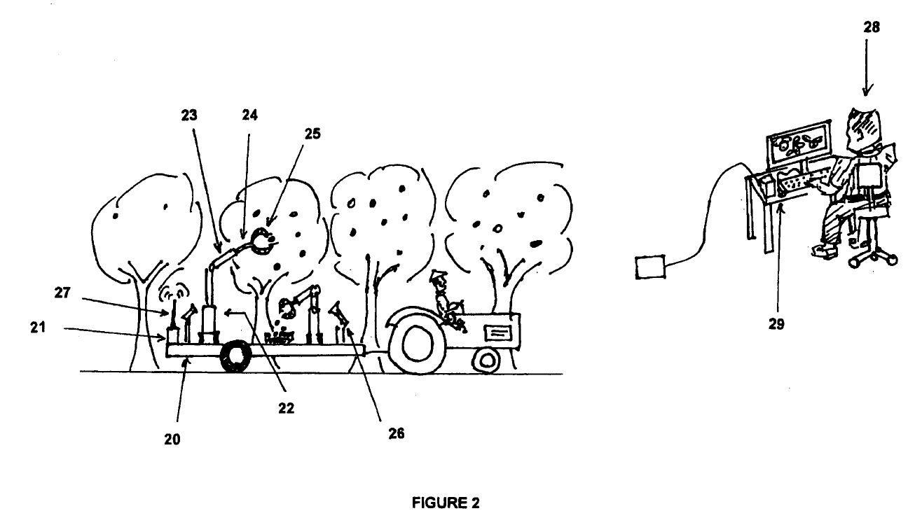

FIG. 2 illustrates that the present invention can comprise a harvester comprising a base 20. A control unit 21 can be attached to the base 20. A first arm 22 can be hingably attached to the base 20. A second arm 23 can be hingably attached to the first arm 22. A telescopic arm 24 can be attached to the second arm 23. A collection device 25 can be attached to the second arm 23. A camera 26 can be mounted to give an image of the plant being harvested. Antennas and/or cables 27 can transmit the image received by the camera 26 to a remote location. A computer and/or user 28 can be at the remote location to receive the image. A pointer device 29, such as a mouse, can be for the user to identify objects, such as fruit or vegetables, to be picked.

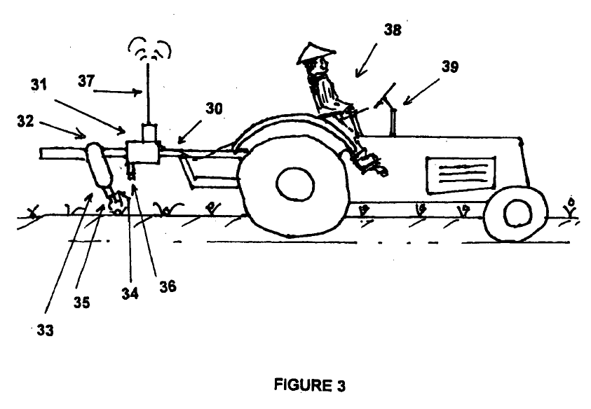

FIG. 3 illustrates an alternative embodiment to the present invention that can have a base 30. A control unit 31 can be attached to the base 30. A first arm 32 can be hingably attached to the base 30. A second arm 33 can be hingably attached to the first arm 32. A telescopic arm 34 can be attached to the second arm 33. A collection device 35 can be attached to the second arm 33. A camera 36 can be mounted to give an image of the plant being harvested. Antennas and/or cables 37 can transmit the image to a remote location. A computer and/or user 28 at the remote location can receive the image. A pointer device 29, such as a mouse, can be used by the user to identify objects, such as fruits or vegetables, to be picked.

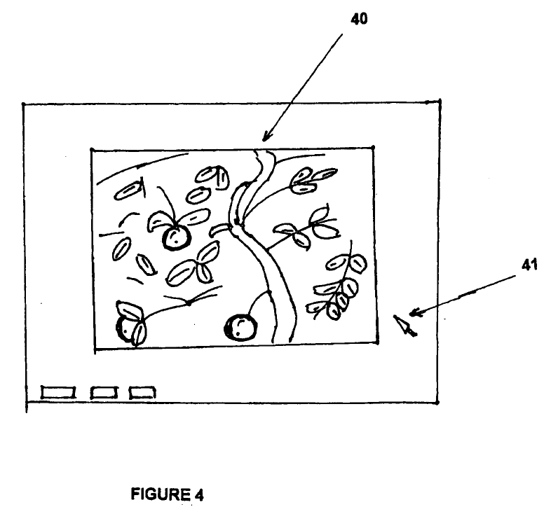

FIG. 4 illustrates the remote user screen view comprising a view of the image taken by the camera and transmitted to the remote user 40, and a moveable pointer 41 controlled by the pointer device 29 used to select fruit to be harvested. The act of controlling the pointer can be accomplished by any number of means, for example a mouse, joystick, touch screen, or touchpad.

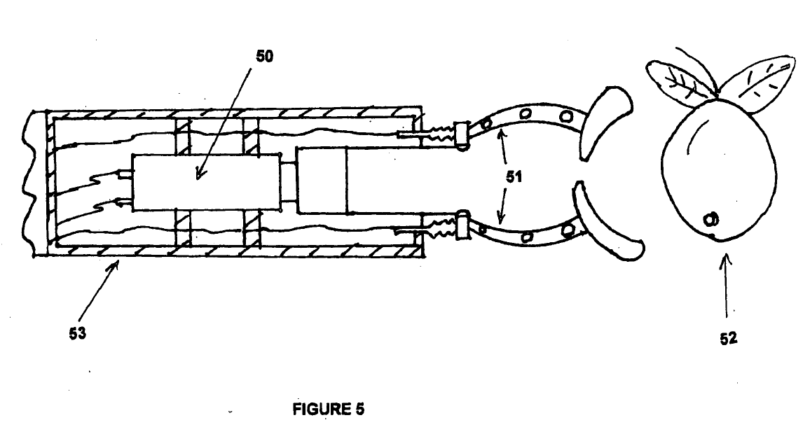

FIG. 5 illustrates that the collection device 53 can have a multiplicity of sensors to approach and collect the targeted fruit. The collection device 53 can have a camera 50. The collection device 53 can have arms 51 for collecting the agricultural product 52.

The system can be controlled by a computer. The computer can send information to, and/or receive information from, the remote user via cables and/or wireless communication. The information the computer can receive from the remote operator can include the approximate location of the object to be harvested, following calculations converting the pixel and timing information related to the object into a spatial coordinate that coincides with the approximate location of the object to be harvested.

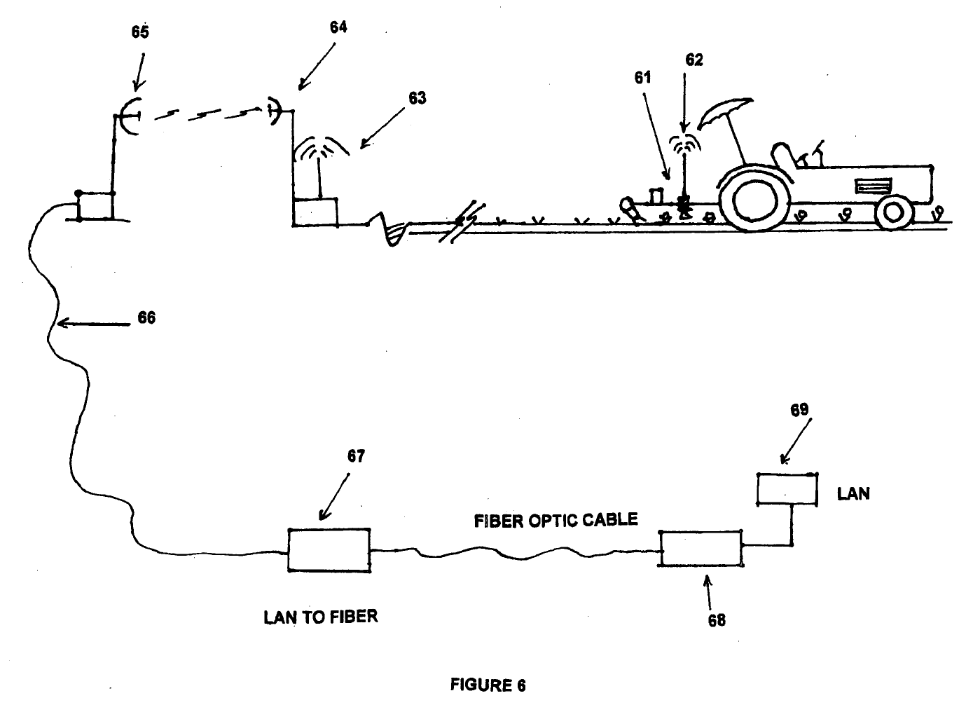

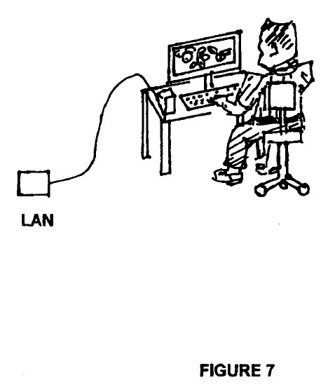

FIG. 6 illustrates that the harvester can have a computer 61. The harvester can have an antenna 62. The harvester can have a relay station 63 for the antenna 62 on the harvester. The harvester can have another antenna 64 to transmit and/or receive information long distances to a remote antenna 65. The harvester can have a network cable 66 to transmit and/or receive information to a communication node 67 connected to another network cable, and a communications node 68 to transmit and receive information to the network 69 connected to the remote user of FIG. 7.

The computer 61 can store the approximate location of the object 52 to be harvested in memory, and then can guide the collection device to the approximate location of the object 52. The collection device 53 can then use sensors to locate and harvest the fruit. The harvester is driven through a field. The field operator 38 can steer the harvester down plant rows. The field operator 38 can communicate with the remote operators with a panel 39 connected to the computer 31.

The video camera 35 can produce standard NTSC output signal. The output signal can be converted to a digital data by a frame grabber in the control unit 31. Any number and/or type of cameras 35 can be used.

The control means can be accomplished with a user interface implemented on a computer using a mouse to control the moveable pointer. The image on the computer screen can be taken by the camera and relayed to the computer over a combination of wireless and non-wireless devices. The image can be of the plant and objects to be harvested. The remote operator will then assist the harvester by identifying objects of the preferred type, size, and ripeness for picking. The remote operator uses the pointing device 41 to select the identified object. To select the identified object, the remote user can either push a button in conjunction with selecting the object, or if using a touch screen can select the object by touching the image of the object. In one preferred embodiment, once the object is selected, the remote computer relays the location of the selected object by sending the XY pixel coordinates of the selection to the harvester over the communication link. The harvester then calculates a vector based on pointing direction of the of the camera when the image was taken. The harvester now has information on the location of the object to be picked. Using this information, the harvester can position the collection device 25 in proximity to the produce. In one preferred embodiment, the collection device 25 is positioned by commanding the collection device to travel along the vector from the camera towards the object to be picked until the collection device detects the object to be picked. The harvester control unit 21 uses sensors in the collection device 25 to zero in on and collect the object to be harvested. An alternative embodiment may use the camera 50 as a close up inspection device for the remote operator 28 to further zero in on the object to be harvested. In accordance with an alternative embodiment, the collection device can travel directly to the approximate location of the object to be picked if the approximate distance between the camera and the selected object is known.

In addition to the camera image being sent from the harvester to the remote operator, the preferred embodiment comprises each image having timing information attached to the image in a digital format. This timing information is sent back to the harvester when the remote operator selects an object to be harvested. This information is used by the harvester computer 21 to calculate the approximate location of the objects to be harvested. This information is needed in the case that the harvester moves between the time it captures and sends an image and the time it receives the pixel location information for a selected object to be harvested from the remote operator.

The collection device of this invention can utilize a multiplicity of sensors to approach and harvest the produce. These sensors can cooperate with the mechanical structure. Any of the mechanical structures used in the prior art to harvest produce may be advantageously employed with the positioning assistance of this invention.

The collection device can be controlled by the control computer 21. The control computer can use the image generated by the camera 50 to determine a precise location of the produce to be collected after receiving information on the approximate location of the produce from the remote operator. One skilled in the art will recognize that collection device may be comprised of any number of sensors and actuators for finding and collecting produce. By way of illustration and not limitation, the collection device 53 may contain laser range finders, ultrasonic rangefinders, color sensors, visible light cameras, infrared light cameras, UV light cameras, accelerometers, strain gauges, hydraulic actuators, pneumatic actuators, stepper motors, and linear motors.

By way of further illustration and not limitation, other suitable devices or components of devices which may be used or incorporated in the apparatus of this invention for a collection device may be found, e.g., in U.S. Pat. Nos. 5,724,799, 5,544,474, 5,425,225, 4,975,016, 4,674,265, 4,663,925, 4,608,813, 4,532,757, 4,226,075, 4,154,048 and the like. The disclosure of these United States patents is hereby incorporated by reference in their entirety.

FIGS. 1 and 2 depict the harvester in two embodiments with one and two harvesting arms respectively. Although one or two harvesting arms are depicted it will be apparent to those skilled in the art that more than two harvesting arms can be incorporated in the apparatus.

FIGS. 1, 2, 4, and 7 depict a single remote operator, however, it will be apparent to those skilled in the art that more than one operator can be incorporated into the apparatus. For one embodiment, more than one operator can select objects to be harvested for a single collection device. The harvester computer 21 stores the location information of objects to be harvested received over the communications link, and sequentially collects the selected produce.

Communication from the harvester to the remote user can be accomplished by a combination of wireless and non-wireless communication devices. E-Band communication may be used when the for the wireless link between the harvester and relay station 63. The harvester can communicate with the relay station with microwaves or lasers. The communication between the relay station and the harvester can be accomplished with a non-wireless device. A non-wireless device can be a fiber optic cable can be dragged over the ground or held aloft on a trellis. The relay station then may then transmit and receive communication between the harvester and the LAN. In certain embodiments, the relay station has a non-wireless connection to the LAN 67. The LAN 67 then transmits and receives information to and from the communications node 68. In the preferred embodiment, a fiber optic cable is used as the connection from the LAN 67 to the communication node 68. The communication node 68 transmits and receives information to and from the remote operator computer 69.

One skilled in the art will recognize that communication between the harvester and the remote operator can be accomplished by any number of means, including a completely non-wireless connection.

It will also be understood that, in addition to harvesting the device can be used for cultivation, planting, and pruning by use of different tools attached to the device in place of the collection device.

Having described the preferred embodiments herein, it should be appreciated that modifications may be made thereto without departing from the contemplated scope thereof. Accordingly, the preferred embodiments are considered illustrative rather than limiting, the true scope of the invention being set forth in the claims appended hereto.

It is further intended that any other embodiment of the present invention that result from changes in application or method of use or operation, method of manufacture, shape, size, or material which are not specified within the detailed written description or illustrations contained herein, yet are considered apparent or obvious to one skilled in the art are within the scope of the present invention.

I claim:

1. A method of remotely guiding a harvesting device comprising the steps of:
a) taking images using a plurality of cameras at the harvester taking images;
b) a network transmitting and receiving information between the harvester and the remote operator;
c) a remote user interface receiving images from an imaging devices located at the harvester;
d) an operator and computer at the remote user interface selecting objects to be harvested and transmitting the pixel location and timing information derived from the selected object to the harvester;
e) a harvester using the information transmitted from the remote operator and, basing the targeted positioning information on the remote user information, positioning the collection device near the object to be harvested
f) the harvester controller detecting and repositioning the collector as needed for collection of objects to be harvested;
g) the harvester controller commanding the collector to collect the object to be harvested.

2. The method for claim 1 wherein the harvester is receiving location information from more than one remote operator per harvesting arm, and sequentially collecting objects to be harvested after storing the location of the of the objects to be harvested from each remote user.

3. The method for claim 1 wherein the remote operator is receiving information and commands from an operator at the harvester.

4. The method for claim 1 wherein the operator at the harvester is receiving information and commands from the remote operator.

5. An apparatus to provide the remotely assisted guidance of an automated harvesting device comprising:
a) a harvester platform with a control unit, harvester arm comprising a base, hingably attached arms, telescopically attached arms, a collection device, a camera, and a communication device;
b) a remote operator comprising a user interface, pointing device, and network connection;
c) a network to transmit and receive information to and from the harvester and the remote operator;

6. The apparatus of claim 5 wherein said collection device further comprising of an accelerometer, pneumatic actuators, stepper motors, linear motors, strain gauges, and tool for removing harvestable objects from plants.

7. The apparatus of claim 5 wherein said harvester has a plurality of harvester arms and a plurality of collection devices.

8. The apparatus of claim 5 wherein said system has a plurality of remote operators.

9. The apparatus of claim 5 wherein said remote operator uses a pointing device to select objects to be harvested.

10. The apparatus of claim 5 wherein said network comprises a combination of wireless and non-wireless devices to transmit and receive information from the harvester to the remote operator.

11. The apparatus of claim 10 wherein said network comprises non-wireless devices to transmit and receive information from the harvester to the remote operator.

12. The apparatus of claim5 wherein said harvester has an interface which allows the operator at the harvester to communicate with the remote operator.

13. The apparatus of claim 5 wherein said collection device contains a camera linked to the harvester controller.

14. The apparatus of claim 13 wherein the images from the collection device are transmitted to the remote operator.

15. The apparatus of claim 14 wherein the images from the collection device are used to determine highly precise positioning information for the object to be harvested.
